(19) United States
(12) Patent Application Publication
(10) Pub. No.: US 2020/0020311 A1
(43) Pub. Date: Jan. 16, 2020

(54) OPTICAL PICKUP AND STRING MUSIC TRANSLATION SYSTEM

(71) Applicant: National Cheng Kung University, Taipei City (TW)

(72) Inventors: Min-Chun HU, New Taipei City (TW); Chi-Po LIN, Kaohsiung City (TW); Yu-Lun HSU, Taoyuan City (TW); Yu-Chen CHIU, Taipei City (TW)

(21) Appl. No.: 16/130,947

(22) Filed: Sep. 13, 2018

(30) Foreign Application Priority Data
Jul. 10, 2018 (TW) 107124178

(51) Int. Cl. G10H 3/14; G10H 3/18

(52) U.S. Cl. CPC G10H 3/143; G10H 3/188; G10H 3/181

(57) ABSTRACT

A low-cost and high-compatibility optical pickup including a light source, one set of optical sensors, and a controller. The light source illuminates a string assembled on an instrument. The set of optical sensors corresponding to the light source is provided to sense the shading of the string. The controller supplies the sensed data from the set of optical sensors to a system host for recognition of the melody played on the string. Considering the other strings assembled on the instrument, the optical pickup includes other sets of optical sensors to sense the shading of the other strings which are also illuminated by the light source. The controller also supplies the sensed data of the other sets of optical sensors to the system host for recognition of the melody played on the other strings.

### CROSS REFERENCE TO RELATED APPLICATIONS

This application claims priority of Taiwan Patent Application No. 107124178, filed on Jul. 10, 2018, the entirety of which is incorporated by reference herein.

### BACKGROUND OF THE INVENTION

### Field of the Invention

The invention relates to a pickup for string instruments and applications of the pickup.

### Description of the Related Art

The pickups of string instruments generally use electromagnetic technology. Vibrations of a magnetic string change a magnetic flux. Changes in the magnetic flux are sensed by a magnetic pickup for conversion to an alternating current that is then transmitted to an amplifier or a recording instrument via a cable. The magnetic sensing is commonly applied to electric guitars, electric bass, electric violins, etc. Music is converted into electronic signals for amplification, recording, and broadcasting.

However, a magnetic pickup is typically designed for a specific string instrument and has to be packed with the specific string instrument as a complete set of hardware—costly, and unfavorable for flexible applications. As for non-electronic string instruments, the magnetic pickup does not work.

### BRIEF SUMMARY OF THE INVENTION

The present invention proposes an optical pickup, and also proposes a string music translation system using the optical pickup, which facilitates music creation and even teaching.

An optical pickup in accordance with an exemplary embodiment of the present invention has a light source, one set of optical sensors and a controller. The light source illuminates a string assembled on an instrument. The set of optical sensors is provided corresponding to the light source to sense the shading of the string. The controller supplies the sensed data from the set of optical sensors to a system host for recognition of the melody played on the string.

In an exemplary embodiment, the set of optical sensors includes a first optical sensor and a second optical sensor respectively disposed on the first side and the second side of the string.

In an exemplary embodiment, the first optical sensor is disposed at a distance from the string, and the second optical sensor is disposed in the same distance from the string. The distance depends on the vibration characteristics of the string and the dimensions of the first optical sensor and the second optical sensor.

In an exemplary embodiment, the optical pickup has an upper cover and a lower seat. The upper cover mounts the light source and has an aperture for allowing light to pass from the light source to illuminate the string. The lower seat mounts the first optical sensor and the second optical sensor. The string passes through the space between the upper cover and the lower seat. The lower seat is a detachable mechanism for attaching and detaching the optical pickup to and from the instrument.

In an exemplary embodiment, the optical pickup has a wireless communication module. The controller operates the wireless communication module to transmit the sensed data from the set of optical sensors to the system host.

In an exemplary embodiment, the optical pickup has other sets of optical sensors which sense shading of other strings illuminated by the light source. The controller supplies the sensed data of the other sets of optical sensors to the system host for recognition of the melody played on the other strings. In an exemplary embodiment, a string music translation system is provided which include the optical pickup and the system host. The system host processes the sensed data of each set of optical sensors, for recognition of the vibration time, pitch, and sound expression of each string. By the recognition of sound expression, the system host recognizes volume, hammer-ons, pull-offs, and slides and, accordingly, sheet music is composed, tips regarding the sound expression are induced and a tablature is composed.

The string music translation system may be used to implement a variety of teaching systems.

In an exemplary embodiment, the string music translation system further has a screen. The sheet music, the tips for sound expression, and the tablature are displayed on the screen. As the optical pickup captures live music, the system host dynamically updates the sheet music, the tips for sound expression, and the tablature displayed on the screen.

In an exemplary embodiment, the system host transmits the sheet music, the tips for sound expression, and the tablature to a remote screen for Applied to an online remote teaching through a network. As the optical pickup captures live music, the system host dynamically updates the sheet music, the tips, and the tablature displayed on the remote screen.

In an exemplary embodiment, the system host generates digital music based on the recognition of vibration time, pitch, and sound expression. The digital music may be mixed or amplified for displaying. Through a network, the digital music may be transmitted to a remote end to be displayed at the remote end.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates an optical pickup 100 in accordance with an exemplary embodiment of the present invention;

FIG. 2A and FIG. 2B illustrate the mechanical structure of the optical pickup 100 for detecting the vibrations of a single string, e.g. S1, in accordance with an exemplary embodiment of the present invention;

FIG. 3A and FIG. 3B depict light sensing results of the single string S1 in accordance with an exemplary embodiment of the present invention;

FIG. 4 is a block diagram of a string music translation system in accordance with an exemplary embodiment of the present invention;

FIG. 5 is a block diagram that depicts a block 502 for signal processing and a block 504 of applications, which are achieved by using the central processing unit 414 to execute the code 416; and

FIG. 6 illustrates a graphical user interface displayed on a screen 600.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

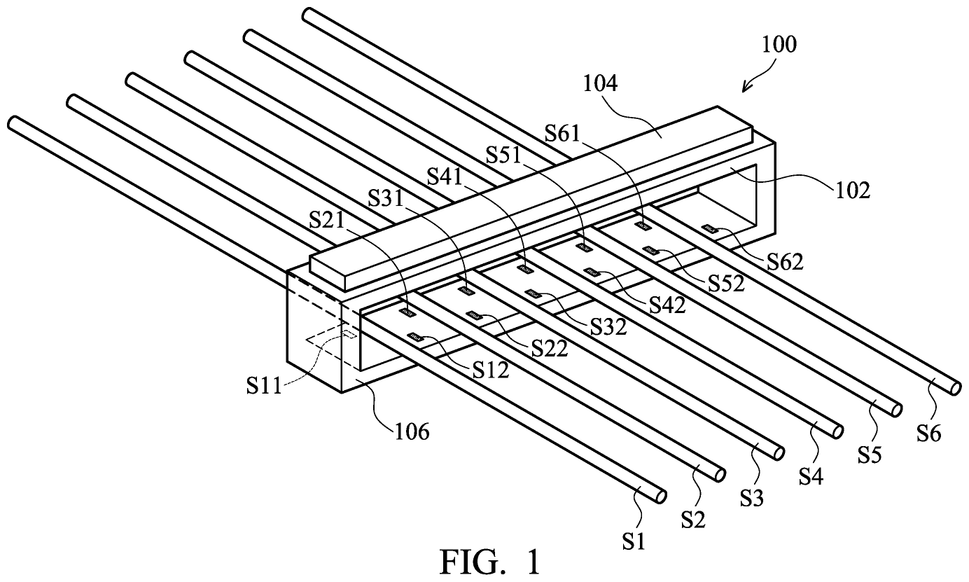

FIG. 1 illustrates an optical pickup 100 in accordance with an exemplary embodiment of the present invention. The optical pickup 100 may be mounted on the body of a string instrument with the strings S1 . . . S6 passing through the optical pickup 100. A light source 104 is mounted on the upper cover 102 of the optical pickup 100. The emitted light passes through the apertures of the upper cover 102 (see the subsequent illustration) and illuminates the strings S1 . . . S6. Six sets of optical sensors (S11, S12) . . . (S61, S62) corresponding to the six strings S1 to S6, respectively, are arranged on the lower seat 106 of the optical pickup 100. The lower seat 106 is a detachable mechanism for the user to easily attach/detach the optical pickup 100 to/from the body of a string instrument. The lower seat 106 mechanism may be telescopic to adapt to the string distance. For example, there are various string instruments, including violins, violas, cellos, guitar, bass and so on each having a unique string distance. The adjustable mechanism of the lower seat 106 allows the optical pickup 100 to be mounted onto any string instrument for audio acquisition.

The light source 104 illuminates the strings S1 . . . S6 and the sets of optical sensors (S11, S12) . . . (S61, S62) sense the string shadows. The changes in light energy sensed by the sets of optical sensors (S11, S12) . . . (S61, S62) reflect the vibrations of the strings S1 . . . S6. Note that the optical pickup 100 performs vibration sensing separately for the six strings S1 . . . S6. The analysis of the sensed light changes is quite simple. For example, vibrations of the string S1 are sensed by the exclusive set of optical sensors (S11, S12) without interfering with other sets of optical sensors (S21, S22), . . . , (S61, S62). In contrast, a magnetic pickup considers the combined vibration of all strings, involving complex analysis and calculations.

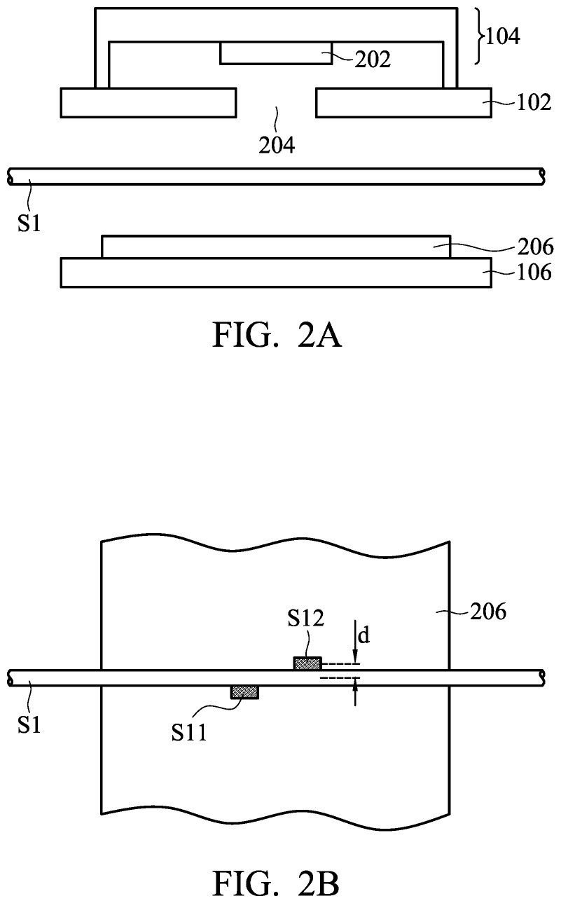

FIG. 2A and FIG. 2B illustrate the mechanical structure of the optical pickup 100 for detecting the vibrations of a single string, e.g. S1, in accordance with an exemplary embodiment of the present invention.

FIG. 2A is a cross-sectional view of the optical pickup 100. Light from the illuminant (i.e. a light bulb) 202 of the light source 104 is emitted through an aperture 204 of the upper cover 102. The lower seat 106 for mounting a light sensing module 206.

FIG. 2B is a top view of the optical pickup 100. Optical sensors S11, S12 are provided by the light sensing module 206 and are disposed on opposite sides of the string S1 which are not aligned side by side as shown. In order to optimize the sensing data, the difference, e.g. d, from each optical sensor to the string S1 may be adjusted in accordance with the vibration characteristics of the string S1 and the dimensions of the optical sensors S11 and S12. In this example, the first optical sensor S11 and the second optical sensor S12 are also disposed at a distance along the string S1.

The illuminant 202 may be a light emitting diode (LED) but not limited thereto. Various shapes are allowed to implement the aperture 204 in the upper cover 102. The shape of aperture 204 may be specially designed to optimize the sensed data.

Rather than the illustrated optical sensors S11 and S12, other embodiments may use other numbers and other arrangements of optical sensors to sense the vibrations of a single string.

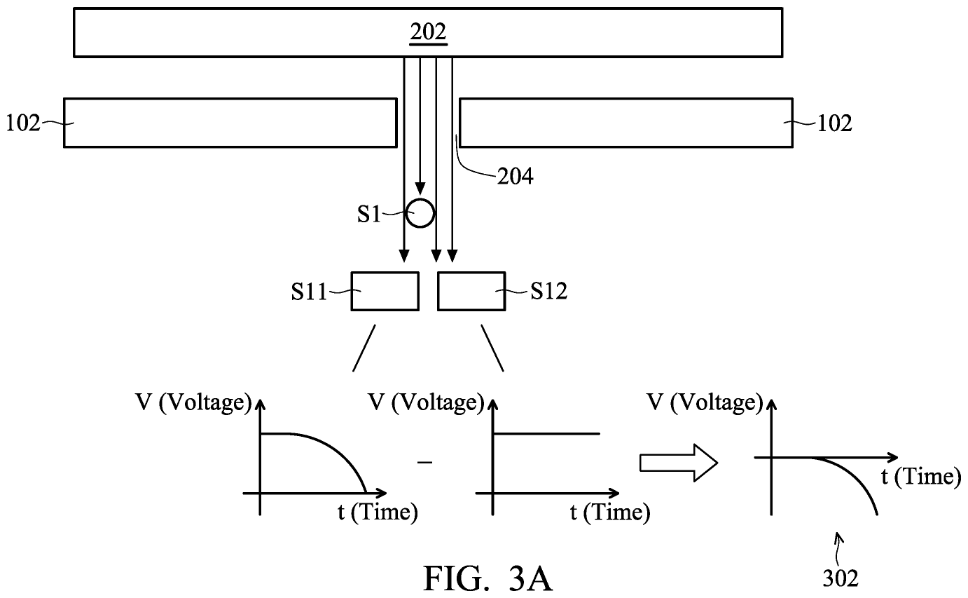

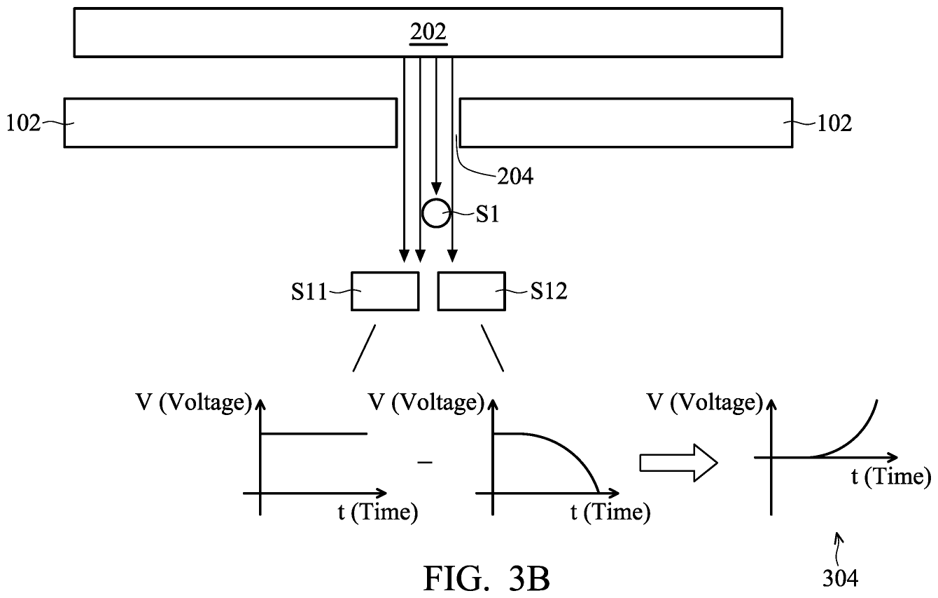

FIG. 3A and FIG. 3B depict light sensing results of the single string S1 in accordance with an exemplary embodiment of the present invention.

Referring to FIG. 3A, when the string S1 vibrates to the left, the light intensity sensed by the optical sensor S11 is decreased. A waveform 302 is generated by subtracting the fixed intensity sensed by the optical sensor S12 from the decreasing data sensed by the optical sensor S11.

Referring to FIG. 3B, when the string S1 vibrates to the right, the light intensity sensed by the optical sensor S12 is decreased. A waveform 304 is generated by subtracting the decreasing data sensed by the optical sensor S12 from the fixed intensity sensed by the optical sensor S11. Both waveforms 302 and 304 can be used to recognize the direction in which the string vibrates. What's more, the vibration time (e.g. onset), frequency (pitch) and amplitude (reflected as the sound expression—including information about volume, hammer-ons, pull-offs, slides, and so on) may be obtained from the waveforms generated by the light sensors. Various processing algorithms can be applied to the captured light data. For example, a Fourier transform may be used to process the captured light data.

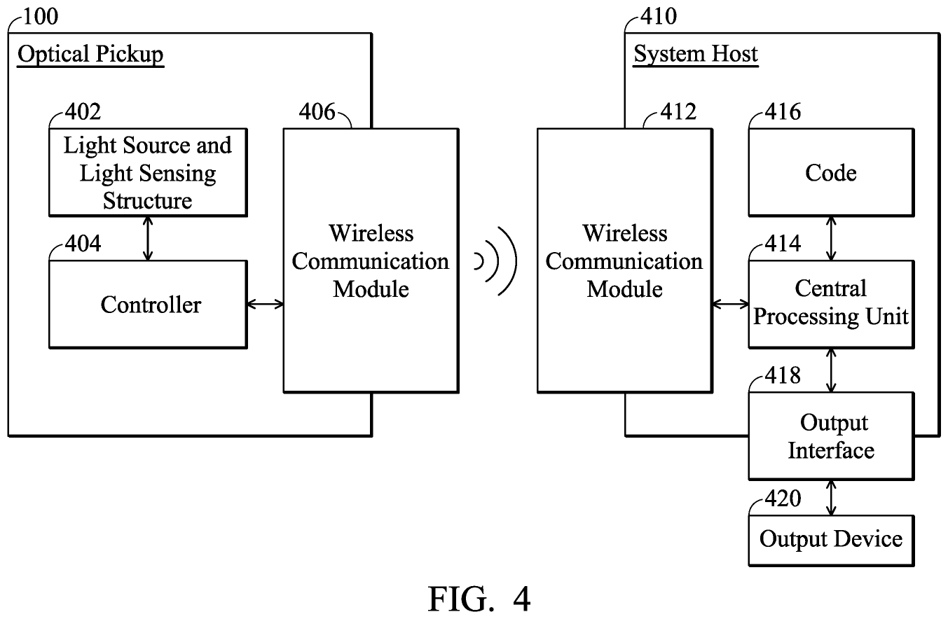

FIG. 4 is a block diagram of a string music translation system in accordance with an exemplary embodiment of the present invention. Other technical details of the present invention for implementing a pickup for string instruments are discussed hereinafter.

In FIG. 4, the aforementioned structure of the optical pickup 100 is referred to as a light source and light sensing structure 402, which is operated by a controller 404. The controller 404 converts the light energy, sensed by the optical sensors (S11, S12) . . . (S61, S62) equipped in the structure 402, into values. For example, the sensed light data may be converted to the voltage values exemplified in FIGS. 3A and 3B. The converted values, then, are transmitted to a system host 410 by a wireless communication module 406 through a wireless communication interface (e.g., WiFi). At the system host 410 side, the data collected by the optical pickup 100 is received by another wireless communication module 412 and passed to the central processing unit 414. By executing the code 416, central processing unit 414 processes the received data for various applications. The system host 410 may use an output interface 418 to output the processed result to an output device 420 for presentation to the user.

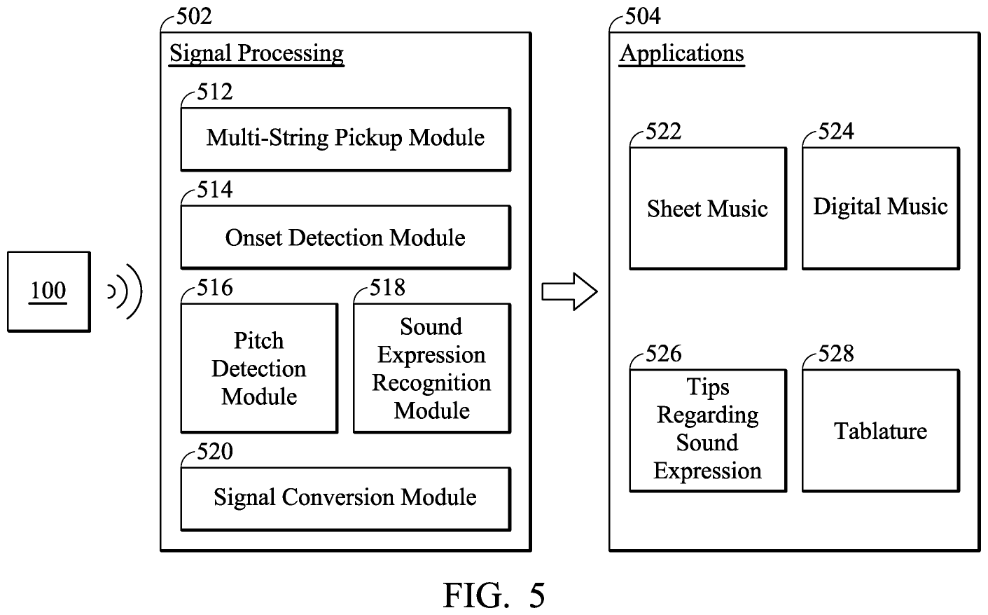

FIG. 5 is a block diagram depicting a block 502 for signal processing and a block 504 of applications, which are achieved by using the central processing unit 414 to execute the code 416.

The block 502 for signal processing may involve a variety of techniques. Light data (e.g. the voltage values of FIG. 3A/3B) detected corresponding to the different strings S1 . . . S6 is collected by a multi-string pickup module 512. The information contained in the light data may be analyzed by several blocks which may employ voltage subtraction operations of FIGS. 3A, 3B or other more complex algorithms. An onset detection module 514 identifies the time point at which the string vibrates. A pitch detection module 516 identifies the vibration frequency to know the pitch. A sound expression recognition module 518 recognizes volume, hammer-ons, pull-offs, slides, and so on, which show the play style. The recognition result may be converted to digital music (such as a MIDI signal) via a signal conversion module 520.

Based on the processed signals from the block 502, the applications implementing the block 504 are diverse. As shown, the applications involve the generation of sheet music 522, digital music 524, tips 526 regarding sound expression (represented by annotations about volume, hammer-ons, pull-offs, slides, and so on), a tablature 528, and so on.

With the optical pickup 100 of the present invention, the live play may be recorded and translated into sheet music immediately. The optical pickup 100 of the present invention also works well for non-electronic string instruments. The live play of non-electronic string instruments may be converted into digital music 524 for mixing.

In an exemplary embodiment, the output device 420 of FIG. 4 is an audio amplifier for playing digital music 524.

In an exemplary embodiment, the output device 420 of FIG. 4 is a screen. The sheet music 522, tips 526 for sound expression and the tablature 528 are dynamically displayed on the screen.

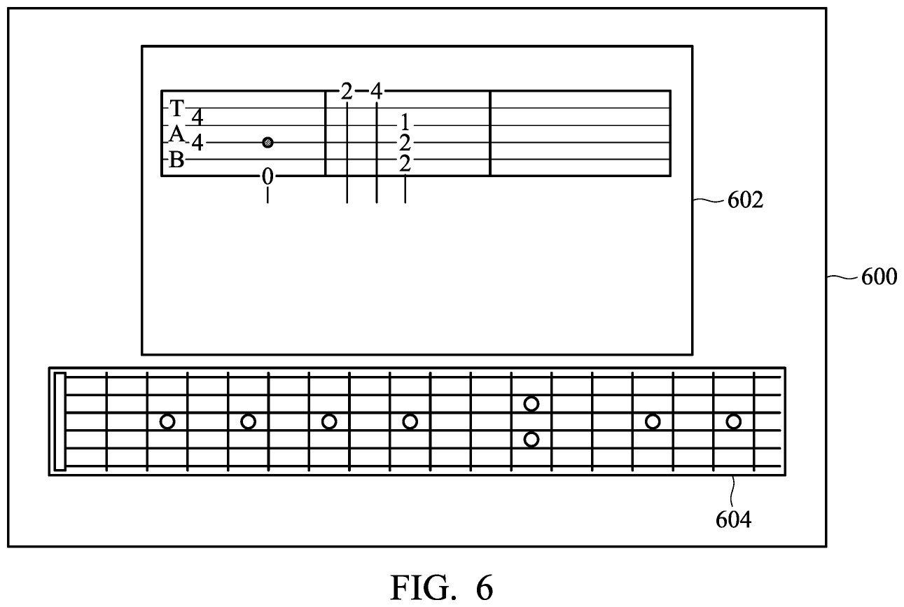

FIG. 6 illustrates a graphical user interface displayed on a screen 600. According to the live music captured by the disclosed optical pickup, the screen 600 dynamically displays the musical notes on the music staff 602, and dynamically displays the fingering on the tablature 604. Tips for sound expression may be also graphically illustrated on the screen 600.

The optical pickup of the present invention is advantageous for teaching use.

In an exemplary embodiment, the live play of a teacher may be captured and translated to digital music to be combined with the corresponding GUI display as a teaching film for students to download.

One implementation is a large classroom or remote teaching. The teacher plays in real time, and the corresponding GUI may be shown on a big screen for the whole class to learn together. Alternatively, the GUI may be transmitted to a remote end in combination with live recorded audio or digital music generated in accordance with the present invention. Via a remote playback device, the students at the remote end can simultaneously participate in the course.

In an exemplary embodiment, the teacher only needs to assemble the optical pickup 100 on a musical instrument and install software on a computer. The aforementioned teaching system, therefore, is constructed by the musical instrument with the optical pickup 100, the computer running the software, and a screen (and an audio amplifier) connected to the computer.

In another exemplary embodiment, the system host 410 of FIG. 4 may be a special-purpose chip or a computer exclusively made for constructing the teaching system. In an exemplary embodiment, the system host 410 is a chip which is packaged in the housing case of the teaching screen.

The detachable optical pickup 100 allows the teacher to demonstrate various string instruments (no matter electronic or non-electronic string instruments) using the same teaching system.

Any technique using the aforementioned optical pickup technology may be regarded as being within the scope of the invention. A musical pickup capturing the tone played on a single string is also a possible implementation.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An optical pickup, comprising:
a light source, illuminating a string assembled on an instrument;
a set of optical sensors corresponding to the light source, sensing shading of the string;
a controller, supplying sensed data from the set of optical sensors to a system host for recognition of a melody played on the string; and
a lower seat that is a detachable mechanism for attaching and detaching the optical pickup to and from the instrument,
wherein the structure of the optical pickup is telescopic to adapt to another instrument.

2. The optical pickup as claimed in claim 1, wherein:
the set of optical sensors includes a first optical sensor and a second optical sensor on the same plane and respectively disposed on a first side and a second side of the string.

3. The optical pickup as claimed in claim 2, wherein:
the first optical sensor and the second optical sensor are disposed at a distance from the string; and
the distance depends on vibration characteristics of the string and dimensions of the first optical sensor and the second optical sensor.

4. The optical pickup as claimed in claim 1, further comprising:
an upper cover for mounting the light source, wherein the upper cover has an aperture for allowing light to pass from the light source to illuminate the string, and there is no lens in the aperture,
wherein:
the lower seat is for mounting the first optical sensor and the second optical sensor and
the string passes through a space between the upper cover and the lower seat.

5. (canceled)

6. The optical pickup as claimed in claim 1, further comprising:
a wireless communication module,
wherein the controller operates the wireless communication module to transmit the sensed data from the set of optical sensors to the system host.

7. The optical pickup as claimed in claim 1, further comprising:
other sets of optical sensors, sensing shading of other strings illuminated by the light source,
wherein the controller supplies the sensed data of the other sets of optical sensors to the system host for recognition of the melody played on the other strings.

8. A string music translation system, comprising:
the optical pickup as claimed in claim 7; and
the system host,
wherein the system host processes the sensed data of each set of optical sensors, for recognition of vibration time, pitch, and sound expression of each string.

9. The string music translation system as claimed in claim 8, wherein:
by the recognition of sound expression, the system host recognizes volume, hammer-ons, pull-offs, and slides.

10. The string music translation system as claimed in claim 8, wherein:
based on the recognition of vibration time, pitch and sound expression, the system host composes sheet music, induces tips regarding the sound expression and composes a tablature.

11. The string music translation system as claimed in claim 10, further comprising:
a screen, displaying the sheet music, the tips, and the tablature; and
as the optical pickup captures live music, the system host dynamically updates the sheet music, the tips, and the tablature displayed on the screen.

12. The string music translation system as claimed in claim 10, wherein:
the system host transmits the sheet music, the tips, and the tablature to a remote screen through a network; and
as the optical pickup captures live music, the system host dynamically updates the sheet music, the tips, and the tablature displayed on the remote screen.

13. The string music translation system as claimed in claim 8, wherein:
based on the recognition of vibration time, pitch, and sound expression, the system host generates digital music.

14. The string music translation system as claimed in claim 13, wherein:
the system host transmits the digital music to a remote end through a network to be displayed at the remote end.
